(19) United States
(12) Patent Application Publication
(10) Pub. No.: US 2003/0132095 A1
(43) Pub. Date: Jul. 17, 2003

(54) Device and method for distilling water

(76) Inventors: Brian Kenet, New York, NY (US); Pedro Joaquin Sanchez Belmar, Murcia (ES)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/047,164

(22) Filed: Jan. 15, 2002

(51) Int. Cl. B01D 3/10

(52) U.S. Cl. 202/182; 203/11; 203/24; 203/26; 203/1; 203/DIG. 17; 203/DIG. 18; 203/DIG. 25; 203/23; 202/205; 159/24.1; 159/44; 159/DIG. 16; 23/306; 210/512.1; 210/513

(57) ABSTRACT

A method for distilling water includes the steps of entering brine to be distilled into a sub-atmospheric boiler having a brine section with a brine output and a water vapor output; concentrating brine in the brine section to a concentration of at least 250 grams of salt or contaminants per liter; stirring the brine in the brine section; and exiting the brine through the brine output. A distiller with a subatmospheric boiler having a stirring device is also provided.

### BACKGROUND OF THE INVENTION

The present invention relates to a method and device for distilling water, for example to desalinate or remove contaminants from water.

Distillation of seawater or contaminated water occurs through boiling water to produce water vapor. The vapor, which largely is free of salt and other contaminants, is then extracted to provide pure distilled water.

In prior art desalinating devices, it has been known to boil seawater at subatmospheric pressures, so that the boiling point of the seawater is lowered. For example, pure water will boil at 1 atmosphere (760 mm Hg) at about 100 degrees Celsius. At a pressure of 0.5 atmospheres, pure water will boil at about 81 degrees Celsius. Salt content however raises the boiling point of water due to boiling point elevation, also known as molecular elevation of the boiling point. For example, one extra gram of salt in a liter of water at atmospheric pressure will raise the boiling point approximately 0.5 degrees Celsius. The boiling point elevation effect is reduced at lower pressures however, so that an extra gram of salt will raise the boiling point temperature by less that the amount at atmospheric pressure. As a result, the boiling point of salt water or brine can be adjusted by controlling the pressure, temperature and salinity of the salt water to be boiled.

Once water has been boiled to form vapor or steam, it is possible to raise the temperature of the steam by compressing the steam, since steam generally follows the perfect or ideal gas law, i.e. PV=RT, where P is pressure, V is volume, R is a constant and T is temperature.

The firm Alfa Laval sells a vacuum vapor compression distiller which functions as follows.

Seawater is fed through a the Alfa Laval distiller so that a distillate stream and a brine stream are output, the brine stream having approximately twice the salinity of the seawater and the distillate stream containing substantially pure water. The seawater first is fed through a filter, is split into two input substreams, one of the substreams being preheated in a heat exchanger by the brine output stream and one by the distillate output stream. The input substreams are then recombined, and the seawater is vented to remove air and NC gases. The seawater then passes into an evaporation chamber of an evaporation condenser, which is a large horizontal cylindrical structure. A vacuum has lowered the atmospheric pressure of the evaporation chamber to a sub-atmospheric pressure. By virtue of the temperature and the pressure in the evaporation chamber, a recirculating brine stream (taken from the seawater and the remains of evaporated brine) evaporates, i.e. boils. The evaporated water vapor then is sent through a vapor compressor, which raises its temperature. The water vapor is then sent back through heat exchanger plates, which reheats recirculating brine and at the same time condenses to form the distillate, i.e. pure water. The reheated brine evaporates due to its increased temperature, thereby forming more water vapor to be sent through the compressor. The brine which is not re-circulated is output from the evaporator condenser by a discharge pump.

The Alfa Laval distiller thus produces a continuous process which outputs a distillate stream and a brine stream having approximately twice the salinity of the incoming seawater.

However, the Alfa Laval distiller has several disadvantages: (1) the brine in the evaporator distiller is split into two substreams: one which is output and one which recirculates to be reheated and evaporated in a plate-type system. This brine has a high salt and/or contaminant content which can foul the piping or plate-type system. Thus an anti-scalant dosing unit is provided to the recirculating brine stream, which can be expensive and complicated. Moreover, even with anti-scalant the plate-type system may fail; (2) an extra filter and an electrical heater also added to the recirculating brine stream. These elements are expensive and also prone to expensive maintenance; (3) the vapor and brine streams must be split into several substreams to be fed through the plate-type system, which thus becomes complicated, expensive and more prone to failure; and (4) the brine output stream has approximately twice the salinity of the seawater, which is too low a concentration for further processing and generally must be considered waste brine. The waste brine stream must generally be returned to a large body of seawater, so as not to environmentally disturb the body of water by increasing its salinity greatly, or be processed in costly and expensive ways such as being deposited in a deep well. Moreover, the distiller cannot be used for decontamination of water with pollutants, as the remaining contaminants are still in a dissolved form.

From U.S. Pat. No. 4,634,533, hereby incorporated by reference herein, it has been known to use certain brines after special processing in a chlor-alkali process. These brines however require an expensive and substantial processing before use. U.S. Pat. No. 5,411,642 discloses a chlor-alkali process, and is hereby incorporated by reference herein.

### SUMMARY OF THE INVENTION

As a result of the above, applicant has disclosed in U.S. patent application Ser. No. 09/502,104 filed Feb. 10, 2000 and related WO 01/58812 (both incorporated by reference herein) a water distiller comprising a sub-atmospheric boiler having a non-recirculating brine section, an input, a brine output and a vapor output, the input for water to be distilled, the brine output for brine, with the vapor output for water vapor. A compressor or other vapor heater is connected to the vapor output and heats the water vapor. An heated vapor line then heats the brine section of the boiler, the heated vapor line eventually outputting the water vapor in condensed form as distillate.

The salt can reach very high concentrations in the water of the boiler, and thus exiting of the brine from the boiler can be problematic.

An object of the present invention is to provide a low maintenance device and method for distilling water which can permit better exiting of brine in the boiler. An additional or alternative method of the present invention is to provide a device and method for distilling water which can produce a high concentration brine or contaminated water stream that can easily exit a boiler to permit extraction of salt or contaminants, or for direct use in a chlor-alkali process.

The present invention provides a water distiller comprising:

a sub-atmospheric boiler having a brine section for holding a brine, an input, a brine output and a vapor output, the input for water to be distilled, the brine output for brine, and the vapor output for water vapor;

a compressor connected to the vapor output for heating the water vapor; and

a stirring device in the sub-atmospheric boiler for stirring the brine.

With the stirring device of the present invention, the distiller of the present invention can provide for much more concentrated brines than in prior art devices without excessive scaling, caking or clumping, which can be output through the brine output. “Brine” as defined herein is water having a high salt or contaminant concentration. The concentrated brines provided by the present device can be easily used as raw material for a clor alkali process, centrifuged, filter pressed or dried to provide salable salt or to provide solid and easily disposable contaminants.

For example, some seawater contains approximately 30 grams of salt per liter. The present device can produce an output brine with a concentration of salt of over 200 grams per liter, or more preferably of a concentration of 300 grams per liter or greater. At this concentration, the brine can be used as raw material in a clor alkali process, centrifuged, filter pressed or otherwise further concentrated to provide salt which can be resold. The distiller of the present invention thus preferably further includes a water removal device connected to the brine output for producing solid salt or waste. The water removed from the centrifuge or other water removal device preferably is returned through the input to the boiler, so that a closed system results, the only outputs being the salt or waste and the distilled water. An advantage of the closed loop between the vacuum tank and the cetrifuge/filter press is that it allows for the economic use of anti-scalants and of heat transfer enhancers.

Preferably, a heated vapor line is connected to an output of the compressor, the heated vapor line heating the brine section. The heated vapor line at the brine section may include a tube bundle heat exchanger.

The brine section preferably is at the bottom of the boiler, and the boiler preferably includes a filter, most preferably made of titanium wool, over brine section. The filter permits vapor to escape but helps retain contaminants and/or salt in the brine. In order to provide for continuous cleaning of the filter, the input may be located above the filter, so that the input water flows over the filter. A second filter may also be provided above the first filter for additional filtering, and may be cleaned periodically.

The heated vapor line may wrap around the outside of the brine section or may pass through the brine section, preferably in coiled form above the stirring device. After condensation, the heated vapor line forms a heated distillate line. Preferably, the heated distillate line passes though a heat exchanger to heat water entering in through the input line to the input of the boiler.

The input line preferably includes an initial silica filter and a venting device, and the heated vapor line preferably ends with a pressure valve, which permits condensed water to pass to the heated distillate line.

The boiler preferably is made of stainless steel and includes a thermal insulator, for example ceramic or an air chamber around the outer surface of an interior vacuum chamber. A vacuum device can be used to initially provide the subatmospheric pressure, and to adjust the pressure when necessary. The vacuum device may be connected to a controller. However, due to the lower corrosivity of the brine, it may also be possible to use high-strength plastic for the boiler, with the attendant cost advantages.

The brine output line preferably is connected to a pump or valve, which is controlled by a controller. The controller is connected at an input to a salinity detector, and can activate the pump when a predetermined salinity is reached in the brine section of the boiler. The pump or valve can pump or release brine from the brine section to the brine output line. The controller may be for example a personal computer with a Pentium-processor from the Intel Corporation, and can activate the pump, when for example a salinity of 300 grams per liter is reached in the brine.

The process may be continuous, or may be a batch-process which can have the advatange of permitting sucking of the brine out of the vaccum tank, which can increase turbulence and reduce scaling.

In a preferred embodiment, the input water is seawater. However, the present invention may also be used with the input water being salt water having a concentration of salt greater than 50 grams per liter. The present invention thus advantageously can be used to process the brine expelled as waste water from other types of desalination devices. The present device thus may further include that the input is connected to an output of a brine producing desalination device, either a reverse-osmosis desalinator or a vapor compression device. The input water also may be polluted water.

In a preferred embodiment, the water to be input is seawater and the seawater enters a silica filter at approximately 23 degrees Celsius, is heated in a heat exchanger to approximately 40 degrees Celsius, is vented and enters the sub-atmospheric boiler, where part of the seawater evaporates instantaneously and a liquid part enters a brine section after passing through and helping clean a titanium wool filter. The evaporated seawater and brine which is evaporating or boiling continuously produces a vapor at about 40 degrees Celsius which passes through a second filter and is compressed. Depending on the salinity desired, the vapor temperature rises due to the compression, for example by about 20 degrees Celsius or more. The heated vapor line then reheats the brine section by passing through the brine section in coiled form, thus aiding the brine evaporation or boiling. The heated vapor after losing some of its heat to the brine section and condensing passes through a pressure valve where the resulting condensed distillate passes through the heat exchanger and exits at approximately 30 degrees Celsius as pure water. The brine is removed periodically when its salinity content reaches between 200 and 350 grams/liter, and is centrifuged, filter-pressed or dried to less than three percent humidity, or is used in a chlor alkali process, for example. The pressure in the boiler may be set to provide boiling of the brine at 40 to 45 degrees Celsius, for example, and is set as a function of the salinity.

Water exited by the filter press or centrifuge may be returned to the boiler. An anti-scalant or heat transfer agent, such as a liquid large molecule organic alcohol for increasing heat transfer

The present invention also provides a method for distilling water comprising the steps of:

entering water to be distilled into a sub-atmospheric boiler having a brine section with a brine output and a water vapor output;

concentrating brine in the brine section to a concentration of at least 200 grams of salt or contaminants per liter;

stirring the brine in the brine section; and

exiting the brine through the brine output.

Preferably, the exiting occurs as a batch process, so that the exiting occurs periodically, rather than continuously, so as to discourage scaling.

The brine preferably may be concentrated so that the concentration of salt, regardless of other contaminants, is more than 250 grams per liter (or per kilogram).

Preferably, the brine may then be used directly in a chlor alkali process, e.g. the chor alkali process disclosed in U.S. Pat. No. 5,411,642, or is centrifuged, filter presses or dried. Water resulting from any of these processes may be returned to the boiler.

A heat transfer agent or anti-scalant can be added to the boiler.

Most preferably the salinity of the brine reaches concentrations greater than 300 grams per liter.

The present invention also provides a method for distilling water and operating a chlor alkali process comprising the steps of:

entering water to be distilled into a sub-atmospheric boiler having a brine section with a brine output and a water vapor output;

concentrating brine in the brine section to a concentration of at least 200 grams of salt or contaminants per liter;

exiting the brine through the brine output; and

processing the brine in a chlor-alkali process.

By providing direct processing for the chlor alkali process, complicated brine creating or processing can be eliminated.

### BRIEF DESCRIPTION OF THE DRAWINGS

The present invention may be better understood with reference to a preferred embodiment in which:

FIG. 1 shows an overview of the distiller of the present invention; and

FIG. 2 is a flowchart of a preferred method according to the present invention.

### DETAILED DESCRIPTION

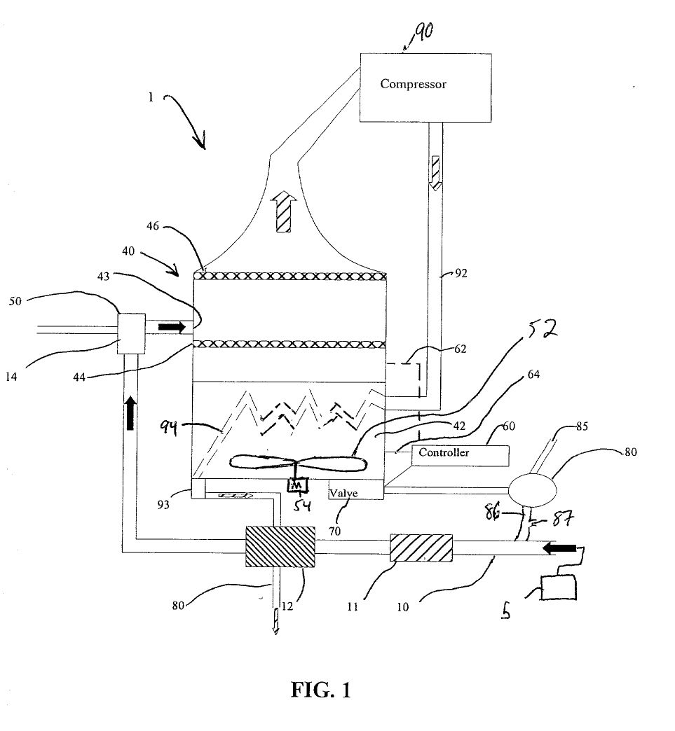

FIG. 1 shows a schematic view of the distiller 1 of the present invention for use with desalinating or decontaminating seawater or exit brines from other desalinators 5, for example with an exit brine with a salinity of about 60 grams per liter. The water to be distilled is pumped or fed to an input line 10, is boiled in a sub-atmospheric boiler 40 to produce water vapor, which condenses and exits as pure water through a distillate output line 80. The flow of water to be distilled is shown generally by solid arrows, and the flow of pure water or water vapor is shown generally by striped arrows. Water to be distilled in input line 10 passes first through a silica filter 11 to remove larger impurities. Input line 10 then passes through a heat exchanger 12 with distillate output line 80. Heat exchanger 12 maybe for example a structure where the distillate output line 80 is coiled within or about an enlarged section of input line 10, or maybe any other type of heat exchanger, such as plate-based heat exchanger. The input line 10 has a venting device 14 for removing air and NC gases from the water to be distilled.

The water to be distilled then flows or is pumped into boiler 40, which is at a low atmospheric pressure. Boiler 40 may be made for example of stainless steel and may be insulated by a ceramic or other known heat insulator. The low pressure can be provided by a vacuum pump 50, which can be connected to a controller 60, which also may have a boiler pressure monitoring line 62. Boiler 40 has at the bottom a brine section 42 where brine collects. A salinity monitoring line 64 is connected to the brine section and provides an input to controller 60, which may be for an Intel PENTIUM processor based computer.

Controller 60 controls vacuum pump 50 and a brine discharge valve or pump 70, which permits the brine in brine section 42 to flow to a centrifuge 80, which can split the brine into salt through centrifuge exit 85 (shown schematically) and water through line 86. Element 80 alternately could be a filter press, dryer or chlor alkali plant. Line 86 can be returned to input line 10 if the water in line 86 is not fully desalinated. An anti-scalant or heat transfer agent can be added at an input 87 to line 86. The heat transfer agent may be for example a liquid large molecule organic alcohol that aids in heat transfer, for example from line 92 at a tube bundle heat exchanger 94 to the brine.

The water to be distilled enters boiler 40 at an input 43 above a titanium wool filter 44. Part of the water evaporates immediately through a second filter 46, and is fed at the low pressure of the boiler to a compressor 90, which compresses the steam so as to heat the steam vapor. Compressor 90 may be for example a positive displacement compressor commercially available from Piller Industrieventilatoren GmbH of Moringen, Germany and may comprise more than one compressor in series.

The heated vapor exits the compressor through a heated vapor line 92, which passes through or about brine section 42 in coiled form, thus reheating the brine in brine section 42. The brine in brine section 42 thus boils, and water vapor passes through filters 44 and 46 to the compressor 90. As the brine concentrates, in order to prevent caking or clumping, a stirring device 52, for example a propeller-shaped stirrer driven by a motor 54, rotates to move the brine.

The water to be distilled which is not evaporated when entering the boiler 40 at input 43 passes through the filter 44 to the brine section 42, and in the process continuously cleans the titanium wool filter by forcing particles caught in the filter to fall back into the brine section 42. Filter 46 can be cleaned periodically.

The water vapor in heated vapor line 92, after transferring heat to brine section 42 passes through a pressure valve 93, by which time the vapor has condensed and passes as generally pure water at a fairly high temperature in distillate output line 80 through heat exchanger 12, where the temperature of the distillate is lowered by providing heat to input line 10.

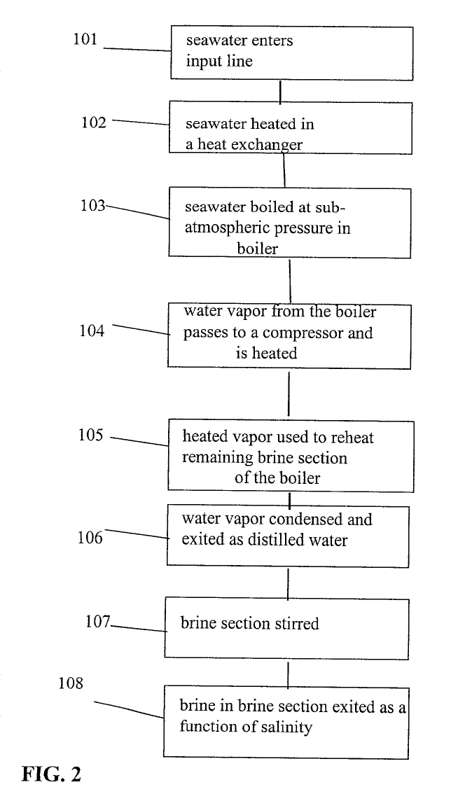

FIG. 2 shows a flowchart of a preferred method of the present invention for use with seawater in the device of FIG. 1. It should be understood however that the present invention may be used to process brines with higher salinity than seawater. In step 101, seawater enters an input line 10 and may be filtered in filter 11. For example, the seawater is at 23 degrees Celsius. In step 102, the seawater is heated in a heat exchanger 12 heated by a distillate output line 80. The seawater may exit the heat exchanger at 40 degrees Celsius, for example. The seawater is then de-aerated and partially boiled at sub-atmospheric pressure in boiler 40, in step 103. The actual pressure in the boiler will vary as a function of the temperature of the seawater and brine, and the salinity of the water. The temperature in the boiler may be 40 degrees Celsius for example, and the pressure below 55 mm Hg depending on the salinity. A vacuum pump 50 may set the pressure in the boiler as a function of the temperature and salinity. Any remaining seawater which does not boil passes to a brine section 42 of the boiler. In step 104, the water vapor from the boiler passes to a compressor 90, for example at 40 degrees Celsius. In compressor 90 the vapor is compressed so as to exit into a heated vapor line 92 at a temperature, for example of 60 degrees Celsius or more. In step 105, the heated vapor line 92 reheats the brine section of the boiler to 40 degrees Celsius. In step 106, the water vapor condenses and is exited as distilled water. In step 107, the brine section is stirred by stirring device 52 so that clumping or caking, which could hamper the exiting of the brine, does not occur. Stirring device 52 can also be used to increase turbulence on any heat exchanger surfaces so as to reduce scaling. In step 108, the valve 70 is then opened as a function of salinity, for example when a salinity level of at least 250 grams per liter is reached, preferably more than grams per liter, so that the brine is exited. A pump may assist in removal of the brine. The exited brine is then used, for example, in a chlor alkali process, centrifuged, filter pressed or dried to provide salt and water, which can returned via line 86 with a heat transfer agent or anti-scalant.

The brine is thus concentrated preferably in batches that are removed as a desired salinity is reached.

In a highly advantageous embodiment, the water to be distilled is waste brine from a desalinating device. Present desalinating devices often require complicated and expensive mechanisms for disposing of their waste brines, which cannot be further processed in a practical manner because the salinity is too low. The present invention permits exit brines of a much higher salinity, for example 250 grams per liter, and thus can be used to desalinate brines with a salinity of up to 150 grams per liter. Most preferably, the salinity of the exit brine of desalination device attached upsteream to the device of the present invention is between 40 and 80 grams per liter.

Liquids other than water may also be decontaminated or desalinated within the scope of the present invention. Also the present invention may have particular application to decontaminating water with pollutants such as oil or heavy metals. Salinity as defined herein includes the concentration of any salts, not just NaCl, and other contaminants that are desirable to be removed in water, and includes the cocentration of salts found in seawater, waste water, water with heavy metals, and brines. Desalination as defined herein includes any process used to remove salts or other contaminants, such as heavy metals, from saltwater, and can include contaminants in septic tank effluent, such as nitrogen.

“Stirring device” as defined herein can include any device used to move water in a tank, and may include a propeller-like stirrer, an air or water jet, air bubble creation device, or any other type of device to aid in mixing the brine.

What is claimed is:

1. A water distiller comprising:
a sub-atmospheric boiler having a brine section for holding a brine, an input, a brine output and a vapor output, the input for water to be distilled, the brine output for brine, and the vapor output for water vapor;
a compressor connected to the vapor output for heating the water vapor; and
a stirring device in the sub-atmospheric boiler for stirring the brine.

2. The water distiller as recited in claim 1 further comprising an output valve for outputting the brine though the brine output when a predetermined brine concentration is reached.

3. The water distiller as recited in claim 2 wherein the predetermined concentration is more than 200 grams per liter.

4. The water distiller as recited in claim 3 wherein the predetermined concentration is more than 300 grams per liter.

5. The water distiller as recited in claim 1 further comprising a water removal device connected to the brine output.

6. The water distiller as recited in claim 5 wherein the water removal device is a centrifuge.

7. The water distiller as recited in claim 1 further comprising a heated vapor line connected to an output of the compressor, the heated vapor line heating the brine section.

8. The water distiller as recited in claim 7 wherein the heated vapor line is above the stirring device.

9. The water distiller as recited in claim 1 further comprising a desalination device connected to the input.

10. An operating water distiller comprising:
a brine having a salinity of at least 200 grams per liter;
a sub-atmospheric boiler having a brine section for holding the brine, an input, a brine output and a vapor output, the input for water to be distilled, the brine output for brine, and the vapor output for water vapor;
a compressor connected to the vapor output for heating the water vapor; and
a stirring device in the sub-atmospheric boiler for stirring the brine.

11. The operating water distiller as recited in claim 10 wherein the brine has a salinity of at least 300 grams per liter.

12. A method for distilling water comprising the steps of:
entering water to be distilled into a sub-atmospheric boiler having a brine section with a brine output and a water vapor output;
concentrating brine in the brine section to a concentration of at least 250 grams of salt or contaminants per liter;
stirring the brine in the brine section; and
exiting the brine through the brine output.

13. The method as recited in claim 12 wherein the concentration is 300 grams per liter or greater.

14. The method as recited in claim 12 wherein the exiting occurs as a batch process, so that the exiting occurs periodically.

15. The method as recited in claim 12 further comprising removing water from the exited brine.

16. The method as recited in claim 15 wherein the water is removed by centrifuging.

17. The method as recited in claim 12 further comprising adding a heat transfer agent to the boiler.

18. The method as recited in claim 12 further comprising adding an anti-scalant to the boiler.

19. A method for distilling water and operating a chlor alkali process comprising the steps of:
entering water to be distilled into a sub-atmospheric boiler having a brine section with a brine output and a water vapor output;
concentrating brine in the brine section to a concentration of at least 200 grams of salt or contaminants per liter;
exiting the brine through the brine output; and
processing the brine in a chlor-alkali process.

20. The method as recited in claim 19 wherein the brine is conce
